(19) United States
(12) Patent Application Publication
(10) Pub. No.: US 2015/0355625 A1
(43) Pub. Date: Dec. 10, 2015

(54) SYSTEMS AND METHODS FOR POSITIONING DEVICES FOR DISPENSING MATERIALS

(71) Applicant: Empire Technology Develpment LLC, Wilmington, DE (US)

(72) Inventor: Harm Cronie, Poliez-le-Grand (CH)

(21) Appl. No.: 14/300,846

(22) Filed: Jun. 10, 2014

(51) Int. Cl. G05B 19/402; G06K 9/18

(52) U.S. Cl. CPC G05B 19/402; G06K 9/18; G05B 2219/45013

(57) ABSTRACT

Systems and methods for freeform additive manufacturing are disclosed. A system includes a positioning device configured to alter location during a manufacturing process of an object. The positioning device includes at least one nozzle configured to dispense a material to create the object. The material can include at least one position code. The positioning device further includes an image sensor configured to create an image of the object and a processor configured to identify the position code based on the image of the object and determine a position of the object based on the position code.

### BACKGROUND

The following description is provided to assist the understanding of the reader. None of the information provided or references cited is admitted to be prior art.

Additive manufacturing involves the creation of three-dimensional objects. Typically in additive manufacturing, the object to be created is surrounded by a support structure. The support structure carries the main additive manufacturing head and can be used for positioning the main head. Therefore the manufacturing process can be limited by the range of motion of the support structure. Additionally, the support structure would need to be scaled proportionally larger than the object to be created.

### SUMMARY

Systems and methods for freeform additive manufacturing are provided herein. In one aspect, the system includes a positioning device configured to alter location during a manufacturing process of an object. The positioning device includes at least one nozzle configured to dispense a material to create the object. The material may include at least one position code embedded within it. The positioning device may include an image sensor configured to create an image of the object. The positioning device may also include a processor configured to identify the position code based on the image of the object and determine a position of the object based on the position code.

In another aspect, there is provided a method for freeform additive manufacturing. The method includes acquiring, by an image sensor of a positioning device, an image of a layer of material of an object. The method further includes extracting, by a processor of the positioning device, a position code from the image of the layer and determining a target position from the position code. The method further includes adapting, by the processor, a printing position until the target position is reached and dispensing, by a nozzle of the positioning device, material on the target position.

In a further aspect, there is provided a method for making a system for freeform additive manufacturing. The method includes creating a positioning device configured to alter location during a manufacturing process of an object. The positioning device may include a body. The body may include a processor configured to identify the position code based on the image of the object and determine a position of the object based on the position code. The method may further include coupling at least one nozzle to the body of the positioning device. The at least one nozzle can be configured to dispense a material to create the object. The material may include at least one position code. The method may further include coupling an image sensor to the body of the positioning device. The image sensor can be configured to create an image of the object.

The foregoing summary is illustrative only and is not intended to be in any way limiting. In addition to the illustrative aspects, embodiments, and features described above, further aspects, embodiments, and features will become apparent by reference to the following drawings and the detailed description.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are; therefore, not to be considered limiting of its scope, the disclosure will be described with additional specificity and detail through use of the accompanying drawings.

FIG. 1 depicts an illustration of a system for freeform additive manufacturing in accordance with an illustrative embodiment.

FIG. 2 depicts an illustration of a positioning device for dispensing materials in accordance with an illustrative embodiment.

FIG. 3 depicts a flow diagram of a method for freeform additive manufacturing in accordance with an illustrative embodiment.

FIG. 4 depicts an illustration of manufacturing an object in accordance with an illustrative embodiment.

FIG. 5 depicts an illustration of a position code embedded in an object in accordance with an illustrative embodiment.

FIG. 6 depicts an illustration of a customized object with multiple position codes embedded in accordance with an illustrative embodiment.

FIG. 7 is a block diagram illustrating a general architecture for a computer system that may be employed to implement various elements of the systems and methods described herein, in accordance with an illustrative embodiment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

Additive manufacturing can involve making a three-dimensional object of various shapes and sizes. Additive manufacturing has the potential to revolutionize the way complex objects are made. Future applications may include construction of large open space structures such as buildings and roads. A large variety of materials may be used. These materials may include composite materials, meta-materials, and smart materials.

Disclosed herein are methods and systems for free-form additive manufacturing. In free-form additive manufacturing, a printing head may be configured to move independent of a support structure and be configured to create a three-dimensional object of various shapes and sizes.

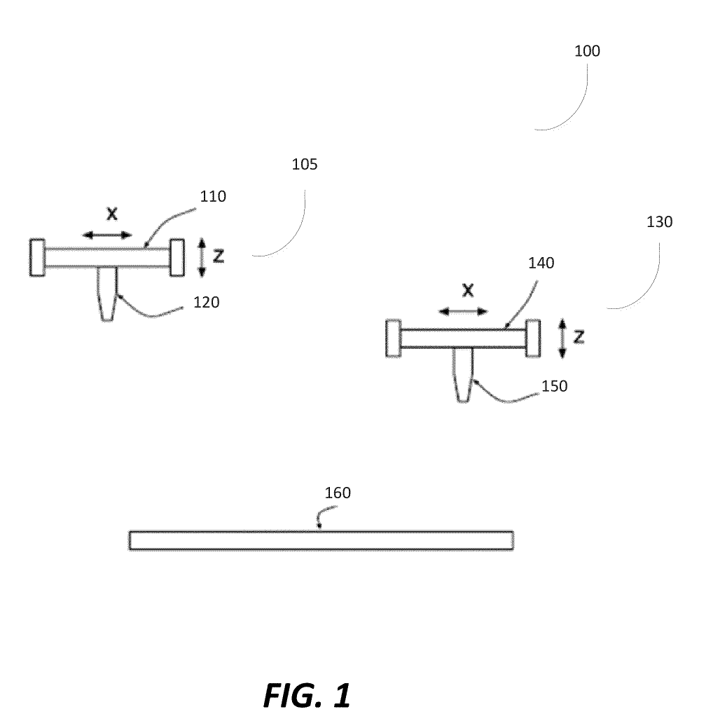

FIG. 1 depicts a system 100 for freeform additive manufacturing in accordance with an illustrative embodiment. In some embodiments, the system 100 for freeform additive manufacturing includes two positioning devices 105, 130 for dispensing materials to create an object 160. In other embodiments, the system 100 for additive manufacturing may include one positioning device 105. In other embodiments, the system 100 for additive manufacturing can include any number of positioning devices 105, 130. The positioning devices 105, 130 are configured to generate a three-dimensional (3D) object 160 by an additive manufacturing process. In an embodiment, the additive manufacturing process may include forming successive layers of material, each layer laid on top of one another. In an embodiment, each of the successive layers of the object 160 can vary in shape and size.

The positioning devices 105, 130 are configured to create a 3D object 160 in a freeform additive manufacturing process. In an embodiment, the positioning devices 105, 130 may not be coupled to a formal structure. In some embodiments, the positioning devices 105, 130 are unmanned devices. The positioning devices 105,130 can be independently powered and operate independent of each other. In some embodiments, the positioning devices 105, 130 may be aerial devices such as flying drones. The flying drones may be self-powered aerial devices that do not carry a human operator. In an embodiment, the flying drones can use aerodynamic forces to provide vehicle lift and can fly autonomously or be piloted remotely.

In some embodiments, the positioning devices 105, 130 are controlled by a central station. The central station may be in a remote location that is a great distance from the positioning devices 105, 130. In other embodiments, the central station may be in close proximity to the positioning devices 105, 130. For example, in one embodiment, the central station can be located at a work site where the positioning devices 105, 130 are manufacturing the object 160. The positioning devices 105, 130 are communicatively coupled to the central station. In one embodiment, the positioning devices 105, 130 may include wireless capabilities, for example and without limitation, Bluetooth and Wi-Fi. In some embodiments, the central station can communicate with a movement control unit of the positioning devices 105, 130. In an embodiment, the central station can determine the target position and transmit the coordinates to the positioning devices 105, 130.

In other embodiments, the positioning devices 105, 130 can operate independent of a central station. Accordingly, the positioning devices 105, 130 may execute a manufacturing process without communication with a central station. In some embodiments, the manufacturing process can be programmed into the positioning devices 105, 130 prior to commencement of the manufacturing process. In an embodiment, the manufacturing program can be entered by a user or administrator. In some embodiments, the manufacturing process can be a computer program entered via a connection to a computing device. In an embodiment, the positioning devices 105, 130 can be connected to the computing device via a wireless connection. In some embodiments, the positioning device 105, 130 can be connected to the computing device via a wired connection or via any communication mechanism known to those of skill in the art. In other embodiments, the manufacturing process can be entered via a user interface on the positioning devices 105, 130.

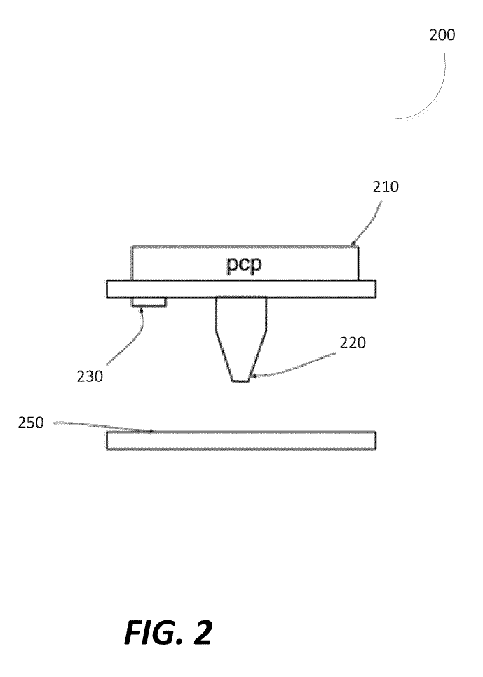

In some embodiments, the position devices 105, 130 can include a body 110, 140 and a nozzle 120, 150, respectively. The positioning devices 105, 130 will be discussed in greater detail below with respect FIG. 2 below.

FIG. 2 depicts a positioning device 200 for dispensing materials in accordance with an illustrative embodiment. In some embodiments, the positioning device 200 includes a body 210, a nozzle 220, and an image sensor 230. In an embodiment, the positioning device 200 dispenses materials via the nozzle 220 to produce an object 250. In some embodiments, the object 250 may be embedded with a position code. In an embodiment, the positioning device 200 may be an aerial device. In some embodiments, the positioning device can be an unmanned device configured to move autonomously such as a flying drone. In some embodiments, the positioning device 200 can be controlled and operated from a central station. In one embodiment, the positioning device 200 can be piloted remotely from the central station.

As indicated above, the positioning device 200 includes a body 210. In an embodiment, the body 210 can house the electronics and possibly other components for the positioning device 200. In some embodiments, the body 210 can be of size large enough to house the electronics, components, and materials for dispensing. The size of the body may be a fraction of the size of the object to be manufactured. For example, in one embodiment, when constructing a building, the body 210 may be of a size about equal to 5% to 10% of the size of the building. The body 210 may be able to hold enough material to allow for efficient constructing without excessive material reloads. In some embodiments, it may beneficial to have a large body 210. In other embodiments, it may be beneficial to have a small body 210. It may be beneficial to use a smaller positioning device 200 and restock often from a stock yard that is nearby the manufacturing site. The shape of the body 210 may be cylindrical or square. In some embodiments, the shape of the body 210 can be created based upon the object to be manufactured and/or the characteristics of the manufacturing site.

In some embodiments, the body 210 can include a position code processing unit, a movement control unit, and a storage unit. In one embodiment, the position code processing unit can include a processor configured to embed a position code into a material during a freeform additive manufacturing process. In some embodiments, the position code processing unit is further configured to extract a position code from an image of the object.

The movement control unit is configured to control the movement of the positioning device 200. In an embodiment, the movement control unit can be communicatively coupled to a central station. In one embodiment, the movement control unit can receive instructions from the central station corresponding to a freeform manufacturing process. In some embodiments, the movement control unit can operate independent of the central station. According to such an embodiment, the movement control unit may be pre-programmed with instructions on forming a 3D object 250. In one embodiment, the movement control unit can control movement of the positioning device 200 to generate the 3D object 250.

In some embodiments, the storage unit holds a material prior to dispensing. In an embodiment, the body 210 can include multiple storage units. In one embodiment, each storage unit can hold different types of materials. In some embodiments, the storage unit can be coupled to the nozzle 220 via a conduit. In an embodiment, the conduit may be a tube. In one embodiment, the conduit can transport material from the storage unit to the nozzle during a freeform additive manufacturing process. The characteristics of the storage unit may depend on the manufacturing materials to be used. In an embodiment, when printing with a polylactic acid (PLA) material or an acrylonitrile butadiene styrene (ABS) material, the material may be available as a filament. In other embodiments, for example, when the material is a type of concrete, the material may be stored in a container in semi-liquid form and transported through the conduit to the nozzle 220. The size of the storage container may depend on the size and/or volume of the object 250 to be manufactured. For example, in one embodiment, when an object 250 is to be manufactured that requires 20 liters of material, the size of the storage container may be 2 liters which implies that a re-stocking needs to be performed 10 times during the manufacturing process. In other embodiments, the size of the storage container may be 20 liters to avoid having to perform any re-stocking during the manufacturing process.

In some embodiments, the nozzle 220 is coupled to the body 210. In an embodiment, the nozzle 220 is configured to dispense a material, for example, during an additive manufacturing process. In some embodiments, the positioning device 200 includes multiple nozzles 220 coupled to the body 210. In an embodiment, the nozzle 220 is coupled to the storage unit via a conduit. In one embodiment, the conduit may be a tube. The conduit is configured to deliver material from the storage unit to the nozzle 220. In an embodiment, an outlet of the nozzle 220 can dispense materials in a variety of ways. In some embodiments, the nozzle 220 can project an image onto the object 250. In such an embodiment, the object 250 would selectively solidify based on the image projected on the object 250 surface. In some embodiments, dispensing may also refer to projecting an image onto a layer of the object 250. In an embodiment, the nozzle 220 can dispense material and project an image.

In an embodiment, the outlet of the nozzle 220 has a large radius, which enables dispensing of materials at a faster rate. In other embodiments, the outlet may have a smaller radius, which enables dispensing of materials at a slower rate (for example, under higher pressure). The rate of dispensing may be measured as amount of material dispensed per time period. For example, in one embodiment, the rate of dispensing may be measured as a kilogram (kg) of material dispensed per second. In an embodiment, the radius of the outlet of the nozzle 220 determines the resolution at which an object is manufactured. A larger radius may correspond to a lower resolution and a smaller radius may correspond to a larger resolution. The required resolution may depend on the specific application. For example, in an embodiment, when manufacturing a thick wall, a resolution of about 1 cm may be appropriate. In other embodiments, other objects may require a larger resolution and correspondingly a smaller radius for the outlet of the nozzle 220.

In an embodiment, the material can be at least one of a composite material, a meta-material, and a smart material. In some embodiments, the material can be a thermoplastic material, for example a polylactic acid (PLA) material or an acrylonitrile butadiene styrene (ABS) material. In one embodiment, the material can be a photo curable polymer. In other embodiments, the material can include at least one of cement or concrete. In still other embodiments, the material can include at least one of metal or metal composites.

In some embodiments, the nozzle is configured to dispense a material embedded with a position code. In an embodiment, the position code is a chemical marking. In some embodiments, the chemical marking is an organic substance. In another embodiment, the chemical marking can be an organic ink that reflects infrared light. In other embodiments, the chemical marking can be an inorganic marking. In some embodiments, the chemical marking includes both organic and inorganic substances. In another embodiment, the chemical includes a luminous material made up of either organic or inorganic material. The luminous material, when excited with a particular wavelength of light (for example, ultra-violet range light), may produce light at another wavelength. The produced light may be detected by the processor to read the embedded position code.

In some embodiments, the position code can include a physical code. The physical code can include a combination of or at least one of symbols, characters, and numerals. In some embodiments, the physical code can be embedded on a surface of the material. In an embodiment, the physical code is visible to the human eye. In other embodiments, the physical code can be invisible to the human eye such that the physical code is only detectable using a reading device (for example, scanner, bar code reader, and so on). In some embodiments, the multiple physical codes can be embedded onto the surface of material.

In some embodiments, the position code can be at least one of a quick response code, a bar code, and a pattern of characters. In an embodiment, the quick response code can be a matrix barcode. In one embodiment, the quick response code can be a two-dimensional barcode. In some embodiments, the quick response code or the bar code can be machine-readable labels. In one embodiment, the bar code may include a series of black bars and white spaces of varying widths to identify the object. In some embodiments, the position code can be a pattern of characters that includes any combination of numbers, alphabetic, and symbols. In one embodiment, the pattern of characters may be a machine readable label.

In some embodiments, the image sensor 230 is coupled to the body 210. In an embodiment, the image sensor 230 may be a digital camera. In some embodiments, the image sensor 230 may be a charge coupled device (CCD) or a complementary metal oxide semiconductor (CMOS) image sensor that captures in the visible light range. In other embodiments, an infrared CCD or infrared CMOS image sensor may be used. In an embodiment, the position code may be an infrared reflective material so that the position code is easily detected when imaged. In one embodiment, the image sensor may incorporate time-of-flight measurements when performing 3D imaging of the object 250. The position codes may encode some information into the z direction. In an embodiment, 3D imaging techniques can be used to determine the z distance of the positioning device 200 to the object 250 being manufactured. In an embodiment, both a CMOS image sensor and a time-of-flight depth sensor can be used. The CMOS image sensor may be used to capture the position codes and decode the x and y position. The depth image sensor may be used to decode the z position.

The image sensor 230 is configured to take an image of the object 250. In an embodiment, the image sensor 230 can transmit the image of the object 250 to other components of the positioning device 200. In one embodiment, the image sensor 230 can transmit the image of the object 250 to the position code processing unit. In some embodiments, the image sensor 230 can convert an optical image into an electronic signal. In one embodiment, the image sensor 230 is configured to transmit the electronic signal to other components of the positioning device 200. In an embodiment, the image sensor 230 is configured to transmit the electronic signal to the position code processing unit. In some embodiments, the image sensor 230 may be part of a camera module coupled to the positioning device 200. In an embodiment, the image sensor can be a two-dimensional (2D) camera or a three-dimensional (3D) camera.

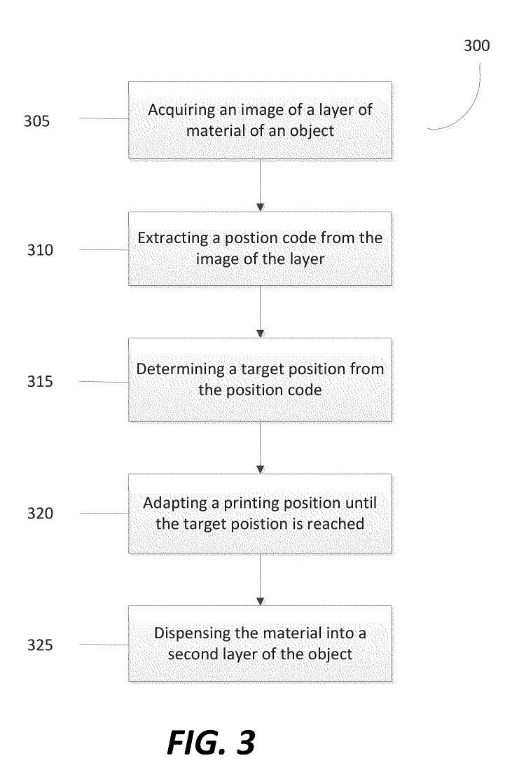

FIG. 3 depicts a flow diagram of a method 300 for freeform additive manufacturing in accordance with an illustrative embodiment. In a brief overview, the method 300 includes acquiring an image of a layer of material of an object (305) and extracting a position code from the image of the layer (310). The method further includes determining a target position from the position code (315) and adapting a printing position until the target position is reached (320). The method also includes dispensing the material into a second layer of the object (325).

As indicated above, the method 300 includes acquiring an image of a layer of material of an object (305). In an embodiment, an image sensor of a positioning device can acquire the image of the layer of material of the object. In some embodiments, the image sensor takes a two-dimensional (2D) image of the object. In other embodiments, the image sensor can take a three-dimensional (3D) image of the object. In some embodiments, the image sensor takes an infrared image of the object. The image sensor transmits the image of the object to other components of the positioning device. In an embodiment, the image sensor transmits the image of the object to the position code processing unit.

In some embodiments, the image sensor takes an optical image of the object and converts the optical image into an electrical signal. In an embodiment, the image sensor transmits the converted electrical signal to other components of the positioning device. In one embodiment, the image sensor transmits the electrical signal to the position code processing unit of the positioning device.

The method 300 further includes extracting a position code from the image of the layer (310). In an embodiment, the position code processing unit analyzes the image of the layer of material of the object to extract the position code. In one embodiment, the processor reads the position code from the image of the object. In some embodiments, extracting the position code can include comparing the image of the layer of the object to a design of the layer of the object. In one embodiment, the design of the layer of the object can be programmed into the position code processing unit. In some embodiments, the design of the layer of the object can be an engineering design of the object. In an embodiment, the engineering design may include detailed diagrams of the object at various stages of manufacture. In one embodiment, the engineering design can be stored within the positioning device or at a central database associated with the positioning device. In some embodiments, the design of the layer of the object can be a computer generated image of the object.

In some embodiments, extracting the position code includes comparing a first image of the object to a second image of the object. In an embodiment, the first image of the object is generated by the processor and the second image of the object is acquired by the image sensor. In one embodiment, the following algorithm can be used to compare the images:

max_{a,b}=Σ_{x,y}I(x,y)*I′(x−a,x−b)

In some embodiments, the inputs to the above algorithm can be the image I(x, y) and the image I′(x, y), where x and y denote the pixel value of the respective image at (x, y). In an embodiment, I(x, y) can represent the image generated by the processor and I′(x, y) represents the image acquired by the image sensor.

The algorithm determines a maximum

$${( max )}_{a , b}$$

value of the correlation between the images for all possible translations of I′. In an embodiment, the resulting (a, b) values can be used as an estimate of the position. In one embodiment, the (a, b) values can be the output of the algorithm.

In some embodiments, the processor can generate the image I(x, y) based on a pre-determined knowledge of the object. In an embodiment, the processor can be programmed with an engineering diagram of the intended object to be manufactured. In some embodiments, based on a current state of manufacture, the processor can generate an anticipated image of what the object should look like at that current state of manufacture.

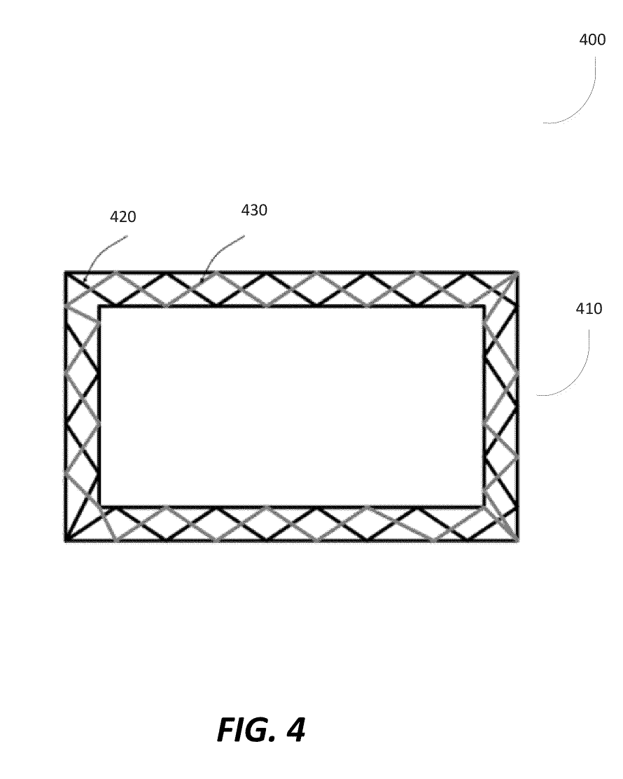

For example, FIG. 4 illustrates an image 400 of an object 410 in accordance with an illustrative embodiment. The object 410 includes a first inner fill layer 420 and a second inner fill layer 430. In some embodiments, the image 400 of the object 410 can be compared to a computer generated image of the object 410, as described above. In an embodiment, the computer generated image of the object 410 can be a design of the inner fill layers of the object 410. In some embodiments, by comparing the image 400 of the object 410 to a design of the object 410 using the above described comparison algorithm, the processor can determine a target position for the nozzle relative to the image sensor. In some embodiments, by comparing the image 400 of the object 410 to a design providing knowledge related to the inner fill layers 420, 430, the processor can adapt a printing position to dispense the next inner fill layer of the object 410.

Referring back to FIG. 3, in other embodiments, the design of an object can change during manufacture. In an embodiment, the first image is stored in a memory of a computing device. In some embodiments, the image (I(x, y) can be a previously stored image of the object taken by the image sensor. In an embodiment, the previously stored image can be compared against a current image (I′(x, y)) acquired by the image sensor to determine a current relative position of the object. In one embodiment, the current relative position of the object can be a target position.

In some embodiments, the method 300 may include pre-processing the second image of the object prior to comparing the second image of the object to the first image of the object. In an embodiment, the image (I′(x, y)) acquired from the image sensor may undergo pre-processing prior to a comparison. In some embodiments, the pre-processing may include at least one of scaling the image, resampling the image, adjusting a brightness level of the image, and adjusting a contrast level of the image. In an embodiment, scaling the image can include re-sizing the image without changing the number of pixels in the image. In some embodiments, re-sampling the image can include changing a number of pixels in the image. In an embodiment, the scaling step and resampling step can be included in the above algorithm. In some embodiments, a scaling or resampling factor “c” can be included in the above algorithm. In an embodiment, the maximization output can include the scaling or resampling factor “c.” In some embodiments, a “z” position of a nozzle can be determined from the resulting “c” value.

The method 300 further includes determining a target position from the position code (315). In an embodiment, determining the target position may include estimating the target position based on the values determined from the comparison algorithm described above. For example, in one embodiment, the (a, b) values can be used as an estimate of the target position. The (a, b) values may correspond to a target location (x, y). In some embodiments, the target position may further include a “z” position. In an embodiment, the target position may be a position of the nozzle. In one embodiment, the target position may include the coordinates (x, y, z), i.e., coordinates in three respective directions.

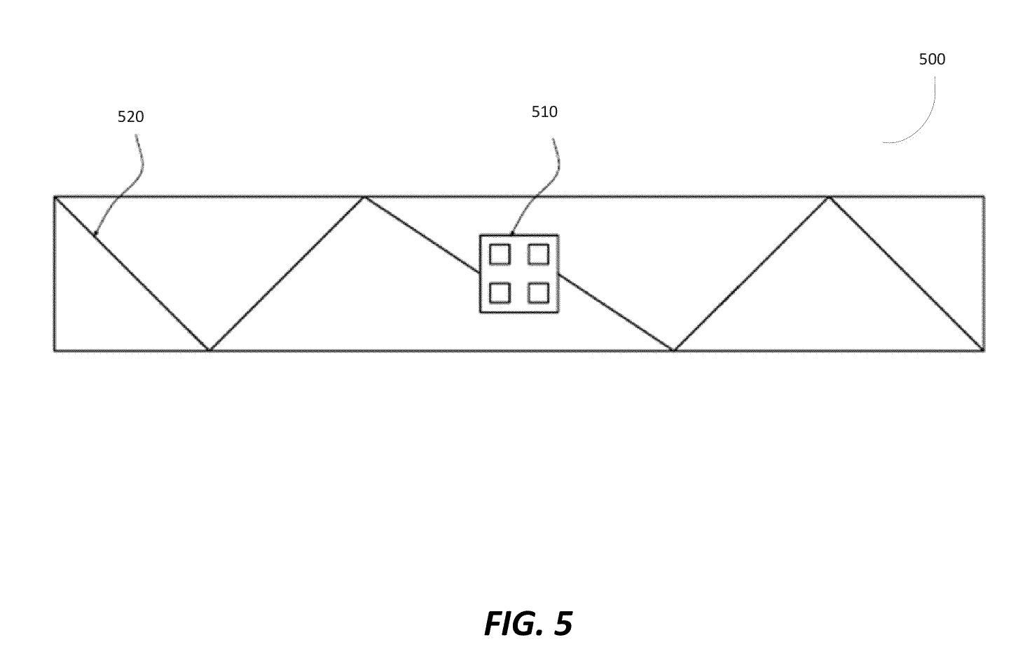

In some embodiments, determining a target position from the position code may include reading the position code from an image of the object. For example, FIG. 5 illustrates an object 500 with an embedded position code 510 in accordance with an illustrative embodiment. The object 500 includes an inner fill layer 520. In an embodiment, the position code 510 may be an explicit structure embedded into the inner fill layer 520 of the object 500. In some embodiments, the position code 510 can be at least one of a quick response code, a bar code, or a pattern of characters. In an embodiment, the position code 510 can be optically recognizable. In one embodiment, the comparison algorithm described above can be used to compare the position code 510 to a design of the inner fill layers of the object 500 to determine the position of a nozzle of a positioning device relative to an image sensor of the positioning device.

Now referring back to FIG. 3, the method 300 includes adapting a printing position until the target position is reached (320). In an embodiment, the positioning device alters a current location based on the target position. In some embodiments, a movement control unit of the positioning device receives coordinates of the target position from the position code processing unit. In an embodiment, in response to receiving the coordinates of the target position, the positioning device moves to the target position to dispense a layer of material. In some embodiments, the positioning device moves autonomously. In an embodiment, the position device can adapt the printing position independent of outside resources. In an embodiment, the movement of the positioning device can be controlled by the movement control unit of the positioning device.

In an embodiment, the positioning device may hover to reach the target position. In other embodiments, the positioning device may be connected to a support structure to guide the positioning device to the target position. However, the support structure would not be used to obtain position information and is not calibrated to position. The position information may be obtained from the position codes present on the object 250 that is being manufactured. After the position code is obtained, in an embodiment, the positioning device may move in a manner that is comparable to conventional 3D printers. In some embodiments, the manufacturing site may be pre-marked with a set of position codes, prior to any layers of the object being printed. The positioning device may detect the position codes and determine where to start dispensing material. The positioning device may then dispense subsequent layers of the object with embedded position codes.

In other embodiments, the movement of the positioning device can be controlled from a central station. The central station may be in a remote location. In other embodiments, the central station may be in close proximity to the positioning device. For example, in one embodiment, the central station can be located at a work site where the positioning device is manufacturing an object. In some embodiments, the positioning device can be communicatively coupled to the central station. In one embodiment, the positioning device may include wireless capabilities, for example and without limitation, Bluetooth and Wi-Fi. In some embodiments, the central station can communicate with the movement control unit of the positioning device. In an embodiment, the central station can determine the target position and transmit the coordinates to the positioning device.

In some embodiments, adapting a printing position includes altering an elevation level of the positioning device. In an embodiment, the positioning device can be an aerial device configured to fly such as a flying drone. In some embodiments, the positioning device can hover above an object during a manufacturing process. In an embodiment, the positioning device can alter the printing position while still hovering above the object and remaining in the air. In other embodiments, the positioning device can return to the central station or a stock yard to pick up more supplies prior to dispensing more material.

The method 300 further includes dispensing the material into a second layer of the object (325). In an embodiment, once the positioning device has reached the target position, the positioning device deposits the second layer of the object. In some embodiments, each time the positioning device reaches a new target position it can dispense a new layer of material of the object. The material of the object can include a position code. In one embodiment, the position code is embedded into the material as the material is dispensed.

In some embodiment, the method 300 includes embedding, by the nozzle, a position code into the material. The position code may identify a target position for the nozzle to dispense a subsequent layer of material of the object. The position code can be embedded as part of structural filling of a solid component of the object. For example, in one embodiment, the position code may be embedded into a wall of the object. In some embodiments, the position code can include specialized position codes. In an embodiment, the specialized position codes can identify a location and/or how to dispense a subsequent layer of material of the object. In one embodiment, the position code can identify a type of material to use in the subsequent layer. In some embodiments, the position code can identify a location for a nozzle to dispense the material. In an embodiment, the position code can identify an amount of the material to dispense for the layer of material of the object, as well how thick the layer should be. In some embodiments, the position code can indicate a rate to dispense the material. In an embodiment, the rate to dispense the material may depend on the type of material to be dispensed.

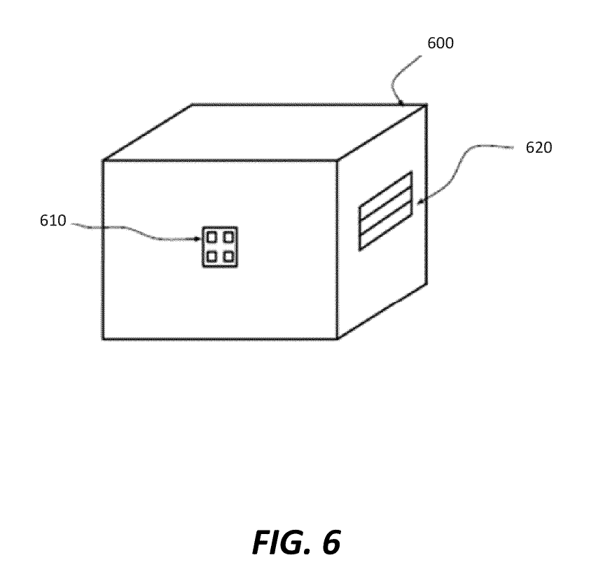

In some embodiments, the position code may encode an identity of the object. The object can be entered into a manufacturing station and the position code can be read. Upon reading the position code, in some embodiments, a user can be presented with options to customize the object. FIG. 6 depicts a customized object 600 in accordance with an illustrative embodiment. In an embodiment, the customized object 600 includes a first position code 610 and a second position code 620. A customization process may include altering the object 600. In one embodiment, the customization process may include altering a shape of the object 600. To direct the customization process, a position code 610, 620 may be embedded into a location on the object 600 to be customized and/or altered. In some embodiments, multiple position codes 610, 620 may be embedded into the object 600, each position code 610, 620 embedded into a different location on the object 600. The position codes 610, 620 can indicate locations on the object 600 to be customized. In one embodiment, additional additive manufacturing may be performed on locations of the object 600 embedded with position codes 610, 620. In some embodiments, information related to the customization of the object 600 can be recorded, for example in a central database. In an embodiment, the stored images can be used to facilitate future customizations of the object.

In some embodiments, the position code may be embedded on an outer surface of the material. In one embodiment, the position code may be embedded in the material such that the position code is still visible on the surface of the material. In some embodiments, the position code may be embedded at a certain depth in the material. In an embodiment, the position code may be embedded such that the position code is detectable using a reading device (for example, scanner, bar code reader, etc.).

In some embodiments, the object includes multiple layers and the position code is embedded into at least one of the multiple layers. Once a layer of material is deposited, a subsequent layer of material can be deposited. This process may continue until all of the layers of the object have been dispensed. Each of the layers of the object may vary in size, shape, depth, and/or material. In an embodiment, the positioning device may alter its current location to dispense the second layer of the object and any subsequent layer of the object.

In some embodiments, the thickness of layers of the object can range from about hundreds of micrometers to about several centimeters. In other embodiments, the thickness of the layers of the object depends on and can be customized for the object to be manufactured. For example, in one embodiment, when printing a case for a tablet computer, the thickness of each layer may be about a few hundred micrometers. In other embodiments, for example when printing a concrete wall, the thickness of each layer may be of several centimeters to provide sufficient resolution. In an embodiment, the thickness of each layer can vary dependent on the type of material to be deposited. In one embodiment, the thickness of each layer can vary dependent on a chemical characteristic of the material to be deposited.

In some embodiments, the method 300 can include overwriting a previous position code with a new position code. In an embodiment, the new position code corresponds to a new layer of the object. In one embodiment, each layer of the material can include a position code. The position code may indicate how to form a subsequent layer. In some embodiments, as each new layer is dispensed, the previous position code can be overwritten by the new layer containing the new position code.

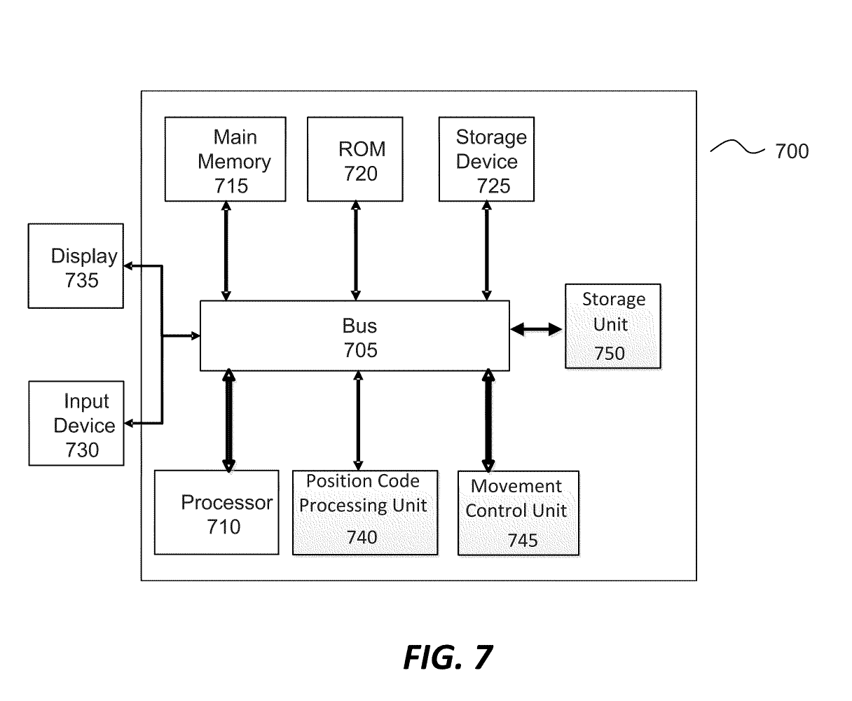

FIG. 7 is a block diagram illustrating a general architecture for a computer system that may be employed to implement various elements of the systems and methods described herein, in accordance with an embodiment. In some embodiments, computer system 700 may be employed to implement one or more aspects of the positioning devices as described above. In an embodiment, the computer system 700 may be housed in the body of a positioning device. In some embodiments, the computer system 700 may include a position code processing unit 740, a movement control unit 745, and a storage unit 750. In an embodiment, the position code processing unit 740, the movement control unit 745, and the storage unit 750 can be similar and operate in the same fashion as the position code processing unit, the movement control unit, and the storage unit described above with respect to FIG. 2.

In some embodiments, some or all of the information received, determined, and/or obtained related to an additive manufacturing process can be stored in a data structure in memory element 715. Upon receiving input via the input device 730, processor 710 can access the data structure stored in memory element 715 and display, execute, perform, or otherwise assess the methods as described herein.

In some embodiments, the processor 710 may prompt or otherwise utilize information related to an additive manufacturing process. In some embodiments, the computer system 700 may be configured to receive instructions from a central station. For example and without limitation, an administrator may enter dimensions of a 3D object to be generated. In some embodiments, the instructions may include a design of the object, dimensions of the object, and the required materials to generate the object. In an embodiment, the computer system 700 may be configured to receive additional information related to the additive manufacturing process. For example and without limitation, an administrator may enter information related to a location to pick up the required materials (for example, stockyard) as well as coordinates of where to generate the object. In other embodiments, the computer system 700 can receive instructions in the field. For example and without limitation, the positioning device may include a display 735 and an input device 730. A user may enter information related to the additive manufacturing process into the positioning device via the computer system 700. In an embodiment, the user in the field may adjust or modify the additive manufacturing process by entering information through the input device 730. In some embodiments, the display 735 may display final designs of the object to be generated. In one embodiment, the display may present the different stages and/or layers of the object to be generated for a user to verify the progress.

The computing system 700 may execute on a device such as that depicted in FIGS. 1 and 2. The computing system 700 can include a bus 705 or other communication component for communicating information and a processor 710 or processing circuit coupled to the bus 705 for processing information. The computing system 700 can also include one or more processors 710 or processing circuits coupled to the bus for processing information. The computing system 700 also includes main memory 715, such as a random access memory (RAM) or other dynamic storage device, coupled to the bus 705 for storing information, and instructions to be executed by the processor 710. Main memory 715 can also be used for storing position information, temporary variables, or other intermediate information during execution of instructions by the processor 710. The computing system 700 may further include a read only memory (ROM) 720 or other static storage device coupled to the bus 705 for storing static information and instructions for the processor 710. A storage device 725, such as a solid state device, magnetic disk or optical disk, is coupled to the bus 705 for persistently storing information and instructions.

The computing system 700 may be coupled via the bus 705 to a display 735, such as a liquid crystal display, or active matrix display, for displaying information to a user. In one embodiment, the display 735 may be an interactive display. For example, the display 735 may be a touchscreen. An input device 730, such as a keyboard including alphanumeric and other keys, may be coupled to the bus 705 for communicating information and command selections to the processor 710. In another implementation, the input device 730 has a touch screen display 735. The input device 730 can include a cursor control, such as a mouse, a trackball, or cursor direction keys, for communicating direction information and command selections to the processor 710 and for controlling cursor movement on the display 735.

According to various implementations, the processes described herein can be implemented by the computing system 700 in response to the processor 710 executing an arrangement of instructions contained in main memory 715. Such instructions can be read into main memory 715 from another computer-readable medium, such as the storage device 725. Execution of the arrangement of instructions contained in main memory 715 causes the computing system 700 to perform the illustrative processes described herein. One or more processors in a multi-processing arrangement may also be employed to execute the instructions contained in main memory 715. In alternative implementations, hard-wired circuitry may be used in place of or in combination with software instructions to effect illustrative implementations. Thus, implementations are not limited to any specific combination of hardware circuitry and software.

Although an example computing system has been described in FIG. 7, implementations of the subject matter and the functional operations described in this specification can be implemented in other types of digital electronic circuitry, or in computer software, firmware, or hardware, including the structures disclosed in this specification and their structural equivalents, or in combinations of one or more of them.

### EXAMPLES

### Example 1

### Additive Manufacturing with a Positioning Device

A positioning device is used to create a three-dimensional (3D) object. The positioning device is an unmanned flying drone and is communicatively coupled to a central station at a remote site via a wireless connection. An operator at the central station uploads a digital 3D design of the object to the positioning device and instructions for a manufacturing process to print the 3D object. The digital 3D design is an engineering diagram of the object divided into multiple layers. Each layer of the object has unique characteristics and dimensions. The positioning device creates the 3D object by printing successive layers of the 3D object until the object is complete. The positioning device includes a processor, a nozzle and an image sensor.

The processor of the positioning device receives the digital design of the object, including the information related to the individual layers of the object, and the instructions on the manufacturing process to print the object. Based on the received information related to the 3D object, the positioning device moves independently to a location to print a first layer of the object. The positioning device carries out the manufacturing process independent of any outside resources, such as a human operator or central station. Once the positioning device reaches the location to print the first layer, the nozzle begins dispensing polylactic acid (PLA) material. The nozzle dispenses the polylactic acid (PLA) material to print each layer of the 3D object. As the material is dispensed, each layer is embedded with a position code. The position code is a physical code made up of a series of characters and is visible on the surface on the printed layer. The position code indicates a current state of manufacture of the object (for example, what layer was just printed) and an identity of the object to be printed. After each layer is printed, the image sensor of the positioning device acquires an image of the layer of the object and transmits the image to the processor. The image sensor is a digital camera and takes a 3D image of the layer of the object. The image of the layer includes the position code visible on the surface of the layer. The processor extracts the position code from the image of the layer. Based on the extracted position code, the processor determines a current state of manufacture of the object (for example, how many layers of the object have been printed).

The processor then determines a target position to print the next layer of the object by comparing the current state of manufacture of the object to the original digital model of the object. The processor compares the digital model to the most recent image of the object using the position code as a reference point. From the comparison, the position device can determine a current position of the nozzle above the object being printed. The digital model indicates where the nozzle needs to be located to print the next layer of the object. The processor calculates the distance and direction the positioning device needs to move to position itself in the target position. The target position is the location for the nozzle to begin printing the next layer of the object. The positioning device adapts a printing position of the positioning device until the target position is reached. The positioning device moves independently of any other devices or structures. Once the target position has been reached, the positioning device prints the next layer of the object. As each subsequent layer of the object is printed, the previously layer and its corresponding position code is covered by the new layer. The process repeats until the entire 3D object is created.

### Example 2

### Additive Manufacturing with Multiple Positioning Devices

Two positioning devices are used to create a 3D object. The positioning devices are unmanned flying drones and are communicatively coupled to a central station at a remote site via a wireless connection. Additionally, the positioning devices are communicatively coupled to each other via a wireless connection. An operator at the central station uploads a digital 3D design of the object and instructions for a manufacturing process to print the object to both positioning devices. The digital 3D design is an engineering diagram of the object divided into multiple layers. Each layer of the object has unique characteristics and dimensions. The positioning devices create the 3D object by printing successive layers of the 3D object until the object is complete. The positioning devices alternate on which device prints which layer of the object. The positioning devices each include a processor, a nozzle and an image sensor.

The processors of the positioning devices receive the digital design of the object, including the information related to the individual layers of the object, and the instructions on the manufacturing process to print the object. Based on the received information related to the 3D object, the positioning devices move independently to print each layer of the object. The positioning devices communicate with each other during the printing process. The positioning devices carry out the manufacturing process independent of any outside resources, such as a human operator or central station. Once the positioning devices reach the location to print the first layer, the nozzles of each device begin dispensing polylactic acid (PLA) material. The nozzles dispense polylactic acid (PLA) material to create each layer of the 3D object. After each layer is printed, the image sensor of the positioning device that just printed the most recent layer acquires an image of the layer of the object. The image sensor transmits the image to processors both positioning devices. In this way, both positioning devices know how many layers have been printed at all times. The image sensors on both devices are digital cameras and take 3D images of the layer of the object. The image indicates a current state of manufacture of the object (for example, what layer was just printed). The processors perform several pre-processing steps on the image. The pre-processing steps include adjusting a brightness of the image and adjusting the contrast of the image. The processors then compare the image of the object to the digital model of the object.

The processors compare the digital model to the most recent image of the object. The most recent image indicates the current position of the nozzle for each positioning device. The digital model indicates where each nozzle needs to be to print the next layer of the object. From the comparison, the processors can determine the distance and direction the positioning devices need to move to reach the target position. The target position is the location for each nozzle to begin printing the next layer of the object. The positioning devices adapt their respective printing position until the target position is reached. The positioning devices move independent of any other devices. Once the target position has been reached, the positioning device prints the next layer of the object. The process repeats until the entire 3D object is created.

The examples demonstrate that by using multiple positioning devices, 3D objects of a greater variety with a greater range of dimensions can be created. Without the confinement of a support structure or similar system, the independently moving positioning devices can operate over a larger area and/or in places that would otherwise be impossible. Additionally, the mobility of the positioning devices increases printing speeds and enables printing of different materials and/or different dimensions of layers simultaneously, rather than having to configure the printing head multiple times to cater to the different materials and/or layers.

When printing without a support structure the main problem is that there is no position information. Other methods to provide position information may not provide enough accuracy, for example, a global positioning system (GPS). Further, methods such as using triangulation with an RF marker can be far more complex, greatly increasing the cost of the system and obtaining the required precision is still difficult. The present disclosure and examples described herein provide position information that is accurately obtained from the object itself.

In some embodiments, when printing with a support structure using the methods and systems described herein, the support structure is not used for position determination. In an embodiment, the position codes provide the position of the positioning device relative to the object and this can be performed with great precision. The advantage here is that the position of the support structure relative to the object does not have to be calibrated to the print resolution. Therefore the support structure to be changed easily during printing of the object. For example, in some applications it may be desirable to use a different/larger/smaller support structure for a layer that consists of a different material. The present disclosure and examples provide position information that is accurately obtained from the object itself.

One or more flow diagrams may have been used herein. The use of flow diagrams is not meant to be limiting with respect to the order of operations performed. The herein described subject matter sometimes illustrates different components contained within, or connected with, different other components. It is to be understood that such depicted architectures are merely illustrative, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (for example, “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (for example, the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed is:

1. A system comprising:
a positioning device configured to alter location during a manufacturing process of an object, the positioning device comprising:
at least one nozzle configured to dispense a material to create the object, wherein the material comprises at least one position code;
an image sensor configured to create an image of the object; and
a processor configured to:
identify the position code based on the image of the object; and
determine a position of the object based on the position code.

2. The system of claim 1, wherein the object comprises multiple layers of the material and the position code is embedded into at least one of the multiple layers of the material.

3. The system of claim 1, wherein the material comprises at least one of composite materials, meta-materials, or smart materials.

4. The system of claim 1, wherein the material comprises at least one of polylactic acid and acrylonitrile butadiene styrene.

5. The system of claim 1, wherein the position code comprises at least one chemical marking, the chemical marking comprising an organic substance, an inorganic substance, or both, embedded into the object;
wherein the organic substance comprises an organic ink to reflect infrared light;
and wherein the inorganic substance comprises a luminous material.

6. The system of claim 1, wherein the position code comprises at least one physical code, the physical code comprising at least one of symbols, characters, and numerals on a surface of the object.

7. The system of claim 1, wherein the processor is configured to:
receive the image of the object from the image sensor, wherein the image of the object is a three-dimensional image;
extract the position code embedded in the object from the image of the object; and
determine a target position based on the position code; and
adapt a printing position of the nozzle until the target position is reached.

8. The system of claim 1, wherein the processor is configured to compare a first image of the object to a second image of the object, wherein the first image of the object is generated by the processor and the second image of the object is acquired by the image sensor.

9. The system of claim 1, wherein the positioning device is an aerial device configured to move autonomously.

10. A method comprising:
acquiring, by an image sensor of a positioning device, an image of a layer of material of an object;
extracting, by a processor of the positioning device, a position code from the image of the layer;
determining, by the processor, a target position from the position code;
adapting, by the processor, a printing position until the target position is reached; and
dispensing, by a nozzle of the positioning device, material on the target position.

11. The method of claim 10, further comprising:
embedding, by the nozzle, the position code into the material; and
dispensing, by the nozzle, the material into a second layer of the object, wherein the object comprises multiple layers.

12. The method of claim 10, wherein extracting the position code comprises reading the position code from the image of the layer of the object.

13. The method of claim 10, wherein determining the target position from the position code comprises comparing the image of the layer of the object to a design of the layer of the object.

14. The method of claim 10, wherein determining the target position from the position code comprises:
pre-processing a second image of the object prior to comparing the second image of the object to the first image of the object, wherein pre-processing comprises at least one of scaling, resampling, brightness adjustment, or contrast adjustments; and
comparing a first image of the object to the second image of the object, wherein the first image of the object is generated by the processor and the second image of the object is acquired by the image sensor.

15. The method of claim 10, wherein the position code is embedded into a layer of the object, and wherein the position code comprises at least one of a quick response code, bar code, or a pattern of characters.

16. The method of claim 10, wherein dispensing further comprises overwriting a previous position code with a new position code, wherein the new position code corresponds to a new layer of the object.

17. The method of claim 10, further comprising customizing the object with multiple position codes, wherein each position code is embedded on a location of the object.

18. The method of claim 10, wherein adapting the printing position comprises altering an elevation level of the positioning device.

19. A method comprising:
creating a positioning device configured to alter location during a manufacturing process of an object, the positioning device comprising:
a body of the positioning device comprising a processor, the processor configured to:
identify the position code based on the image of the object; and
determine a position of the object based on the position code;
coupling at least one nozzle to the body of the positioning device, the at least one nozzle configured to dispense a material to create the object, wherein the material comprises at least one position code; and
coupling an image sensor to the body of the positioning device, the image sensor configured to create an image of the object.

20. The method of claim 19, wherein the processor is configured to:
receive the image of the object from the image sensor, wherein the image of the object is a three-dimensional image;
extract the position code embedded in the object from the image of the object;
determine a target position based on the position code; and
adapt a printing position of the nozzle until the target position is reached.
